(19) United States
(12) Patent Application Publication
(10) Pub. No.: US 2009/0147108 A1
(43) Pub. Date: Jun. 11, 2009

(54) CCD signal processing device and image sensing device

(76) Inventors: Yoshinori Okura, Osaka (JP); Yukihiro Tanizoe, Osaka (JP); Tomoharu Miyake, Kyoto (JP)

Correspondence Address: MCDERMOTT WILL & EMERY LLP, 600 13TH STREET, NW, WASHINGTON, DC, 20005-3096, US

(21) Appl. No.: 12/314,204

(22) Filed: Dec. 5, 2008

(30) Foreign Application Priority Data
Dec. 7, 2007 (JP) 2007-316840
Nov. 5, 2008 (JP) 2008-284487

(51) Int. Cl. H04N 9/64

(52) U.S. Cl. 348/249; 348/E09.037

(57) ABSTRACT

A CCD solid-state image sensor alternately outputs, pixel by pixel, N (where N is an integer of 2 or more) lines of image signal and a line of smear signal for correcting the N lines of image signal by switching an output line from one to another. an AD conversion section performs an AD conversion on the output signal from the CCD solid-state image sensor. A smear data separation section separates smear data from the sensor output data output from the AD conversion section and converts the separated smear data to corrective smear data corresponding to each image data. A subtraction circuit performs a smear correction by subtracting, from each image data, the corrective smear data corresponding to the image data. Smear correction is appropriately performed even if a high-brightness object moves.

### CROSS REFERENCE TO RELATED APPLICATION

This application claims priority under 35 U.S.C. §119 on Patent Application No. 2007-316840 filed in Japan on Dec. 7, 2007 and Patent Application No. 2008-284487 filed in Japan on Nov. 5, 2008, the entire contents of which are hereby incorporated by reference.

### BACKGROUND OF THE INVENTION

1. Field of the Invention

The present invention relates to a technique for processing a signal of a solid-state image sensor using CCDs (Charge Coupled Devices) and, more particularly, to a technique for correcting deterioration of the image quality by smear, which occurs when taking a picture of a high-brightness object.

2. Description of the Background Art

When taking a picture of a high-brightness object with a CCD image sensor, there may occur noise called “smear”. This occurs when an excessive charge of a high-brightness portion is mixed into a signal charge that has already been photoelectrically converted and is being transferred by vertical CCDs. Smear appears to be a streak or band of white noise running vertically through a high-brightness portion.

Conventionally, smear is corrected, for example, as follows. In view of the fact that smear occurs through the same column, shaded smear-correcting photoelectric converters are provided at the upper and lower ends of the image sensing section, wherein image data of the same column is corrected through subtraction by using the average value of the OB (Optical Black) data obtained by these photoelectric converters (see Patent Document 1).

Patent Document 1: Japanese Laid-Open Patent Publication No. 2007-110375

### SUMMARY OF THE INVENTION

For example, if a high-brightness object moves while reading out a frame of data, the smeared position also moves with the movement of the high-brightness object. Then, the smear will not appear straight along columns, but will appear as an oblique wavy line. If such smear is corrected through subtraction by using the OB data of the smear-correcting photoelectric converter provided at the upper and lower ends of the image sensing section, there will remain uncorrected smear portions. Moreover, non-smeared portions may be corrected unnecessarily, thereby dropping portions of the image data and deteriorating the image quality.

The present invention has been made in view of such a problem, and has an object to provide a CCD signal processing device, in which smear of image data obtained by a CCD solid-state image sensor can be corrected appropriately even if a high-brightness object moves.

The present invention uses a CCD solid-state image sensor, which alternately outputs, pixel by pixel, N (where N is an integer of 2 or more) lines of image signal and a line of smear signal for correcting the N lines of image signal by switching an output line from one to another. For example, in order to realize such an output scheme, the image signal may be thinned by dropping a line for every N lines by using an appropriate CCD driving method. For each line dropped, only a smear signal present in the vertical transfer CCDs is output. As a result, N lines of image signal and a line of smear signal are output alternately.

The present invention also uses a CCD signal processing device for processing the signal output from the CCD solid-state image sensor, wherein the CCD signal processing device includes: an AD conversion section for performing an AD conversion on the output signal from the CCD solid-state image sensor to output the converted signal as sensor output data including image data and smear data; a smear data separation section for separating smear data from the sensor output data output from the AD conversion section and converting the separated smear data to corrective smear data corresponding to each image data; and a subtraction circuit for performing a smear correction by subtracting, from image data of the sensor output data outputted from the AD conversion section, the corrective smear data corresponding to the image data output from the smear data separation section.

With this invention, corrective smear data corresponding to each of N lines of image data is output from the smear data separation section, and the subtraction circuit subtracts, from each image data, corrective smear data corresponding to the image data, thereby realizing a smear correction. Therefore, it is possible to appropriately perform a smear correction even if a high-brightness object moves.

As described above, according to the present invention, it is possible to appropriately perform a smear correction even if a high-brightness object moves, and it is therefore possible to output image data of a desirable image quality.

### BRIEF DESCRIPTION OF THE DRAWINGS

FIG. 1 is a block diagram showing an image sensing device including a CCD signal processing device according to a first embodiment of the present invention.

FIG. 2 is an example of an output from a solid-state image sensor, showing the relationship between the spatial arrangement of pixels and the order of output thereof.

FIG. 3 shows an actual example of data output in the case of FIG. 2.

FIG. 4 shows the amount of shift in the order of output between the image lines and the smear line.

FIG. 5 shows a specific configuration of a smear sampling section and a level adjustment section.

FIG. 6 shows the relationship between the output from the solid-state image sensor and the line identification counter value and the multiplier for the level adjustment.

FIG. 7 shows an example of a temporal transition of each data in the configuration of FIG. 5.

FIG. 8 is a block diagram showing a configuration of an over-correction suppressing section.

FIGS. 9A and 9B show a correction operation performed by a low smear level correction section.

FIG. 10 illustrates a mechanism of data dropping.

FIG. 11 shows a correction operation performed by a high smear level correction section.

FIG. 12 shows a correction operation performed by a low/high brightness level correction section.

FIG. 13 is a block diagram showing an image sensing device including a CCD signal processing device according to a second embodiment of the present invention.

FIG. 14 is a block diagram showing an image sensing device including a CCD signal processing device according to a third embodiment of the present invention.

FIG. 15 shows a specific configuration of a smear consecution detection circuit.

FIGS. 16A and 16B illustrate a determination operation of a smear consecution detection circuit.

FIG. 17 shows an example of a correction operation performed by an over-correction suppressing section.

FIG. 18 is a block diagram showing an image sensing device including a CCD signal processing device according to a fourth embodiment of the present invention.

FIG. 19 shows a specific configuration of a smear position change detection circuit.

FIG. 20 illustrates a determination operation of a smear position change detection circuit.

FIG. 21 shows an example of a correction operation performed by an over-correction suppressing section.

### DETAILED DESCRIPTION OF THE INVENTION

Embodiments of the present invention will now be described with reference to the drawings.

### First Embodiment

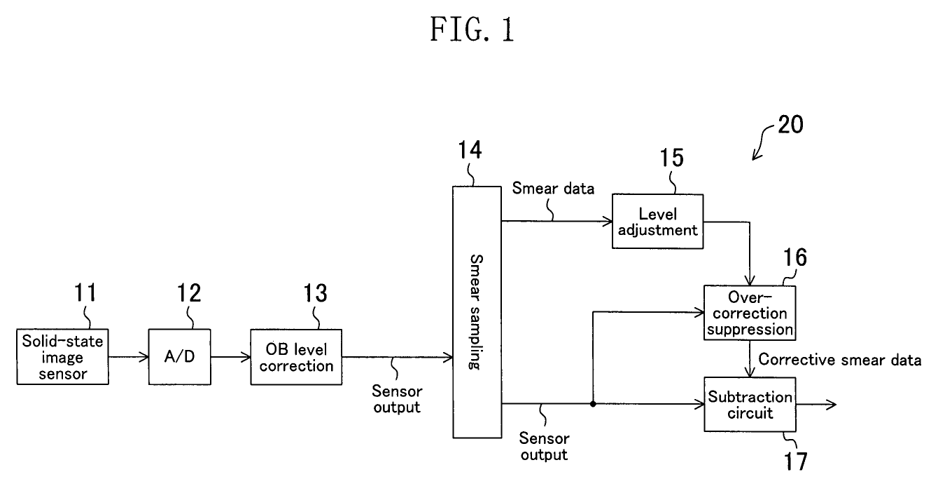

FIG. 1 is a block diagram showing an image sensing device including a CCD signal processing device according to a first embodiment of the present invention. Referring to FIG. 1, reference numeral 11 denotes a solid-state image sensor using CCDs, reference numeral 12 an AD conversion section for performing AD conversion on the output signal from the solid-state image sensor 11, reference numeral 13 an OB (Optical Black) level correction section, reference numeral 14 a smear sampling section for extracting smear data from the sensor output data, which has been subjected to AD conversion and OB level correction, reference numeral 15 a level adjustment section for adjusting the level of the extracted smear data, reference numeral 16 an over-correction suppressing section for correcting the extracted smear data for suppressing over-correction, i.e., excessive smear correction through subtraction, and reference numeral 17 a subtraction circuit for correcting smear by subtracting the smear data from the sensor output data.

The A/D conversion section 12 and the subsequent components together form the CCD signal processing device. The smear sampling section 14, the level adjustment section 15 and the over-correction suppressing section 16 together form a smear data separation section 20 for separating smear data from the sensor output data and converting the separated smear data to corrective smear data corresponding to each image data.

The solid-state image sensor 11 has the following configuration so as to realize an effective smear correction. The solid-state image sensor 11 is capable of outputting N (where N is an integer of 2 or more) lines of image signal together with a line of smear signal corresponding to the N lines of image signal. The solid-state image sensor 11 alternately outputs, pixel by pixel, the N lines of image signal and a line of smear signal by switching an output line from one to another.

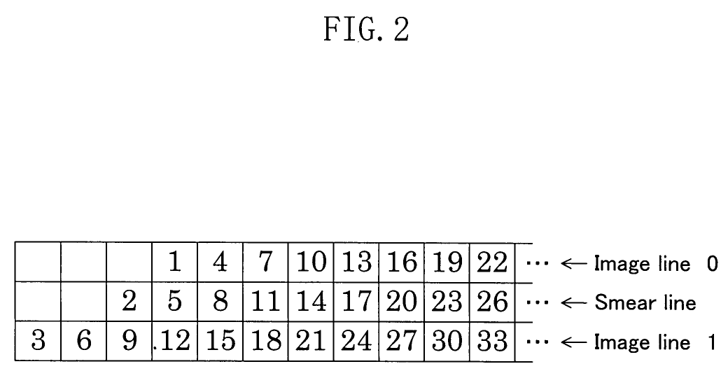

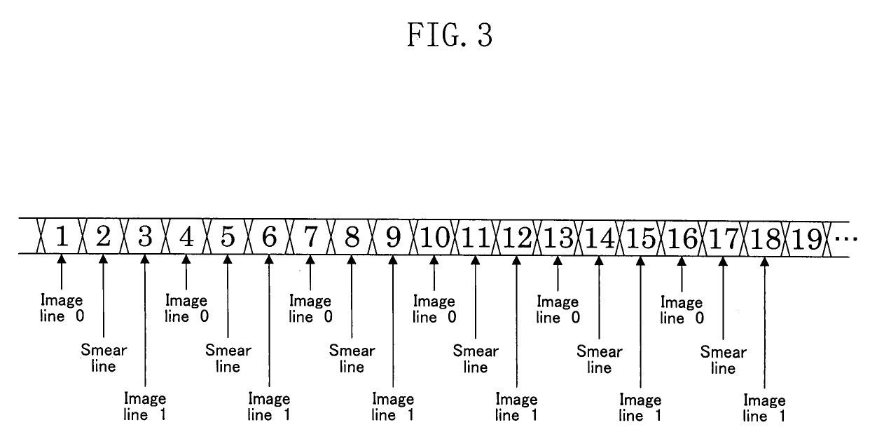

In the present embodiment, N=2, i.e., the solid-state image sensor 11 outputs two lines of image signal together with a line of smear signal. FIG. 2 is an example of an output from the solid-state image sensor 11, showing the relationship between the spatial arrangement of pixels and the order of output thereof. Each number represents the order of output. The first line is the image line 0, the second line is the smear line, and the third line is the image line 1. FIG. 3 shows an actual example of data output in the case of FIG. 2.

Specifications of the solid-state image sensor 11 of the present embodiment are as follows.

1) Which one of the three lines is the smear line is unknown.

Specifically, while the smear line is the second line in the example of FIG. 2, it may alternatively be the first line or the third line. During the CCD signal processing operation, however, it is known which one of the lines is the smear line.

2) The amount of horizontal position shift between lines is unknown.

Specifically, while the second line is shifted from the first line by one pixel to the left and the third line is shifted from the first line by three pixels to the left in the example of FIG. 2, the shift amount is unknown. For example, the third line may be shifted from the first line by one pixel to the right. During the CCD signal processing operation, however, it is known about how much the shift amount is.

3) The amount of shift in the order of output between image data and smear data in the same column is unknown.

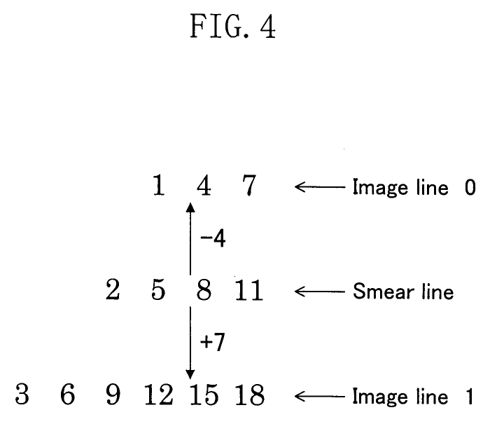

Specifically, while the amount of shift in the order of output between the image line 0 and the smear line is −4 and that between the image line 1 and the smear line is +7 (see FIG. 4) in the example of FIG. 2, the amount of shift is unknown. During the CCD signal processing operation, however, it is known about how much the shift amount is. It is assumed in the present embodiment that the amount of shift is up to ±8. Note however that the acceptable range of the shift amount is not limited to ±8.

An OB level correction section 13 corrects the OB level of the data output from the A/D conversion section 12. For example, the image data in the OB area are integrated in advance, with the OB level correction value being obtained from the average value thereof. Then, the OB level correction value is subtracted from the output data. While it is preferred that image data of the OB area in the same frame is used, image data of the OB area in a previous frame may be used, for example. Alternatively, the OB level correction value may be set arbitrarily.

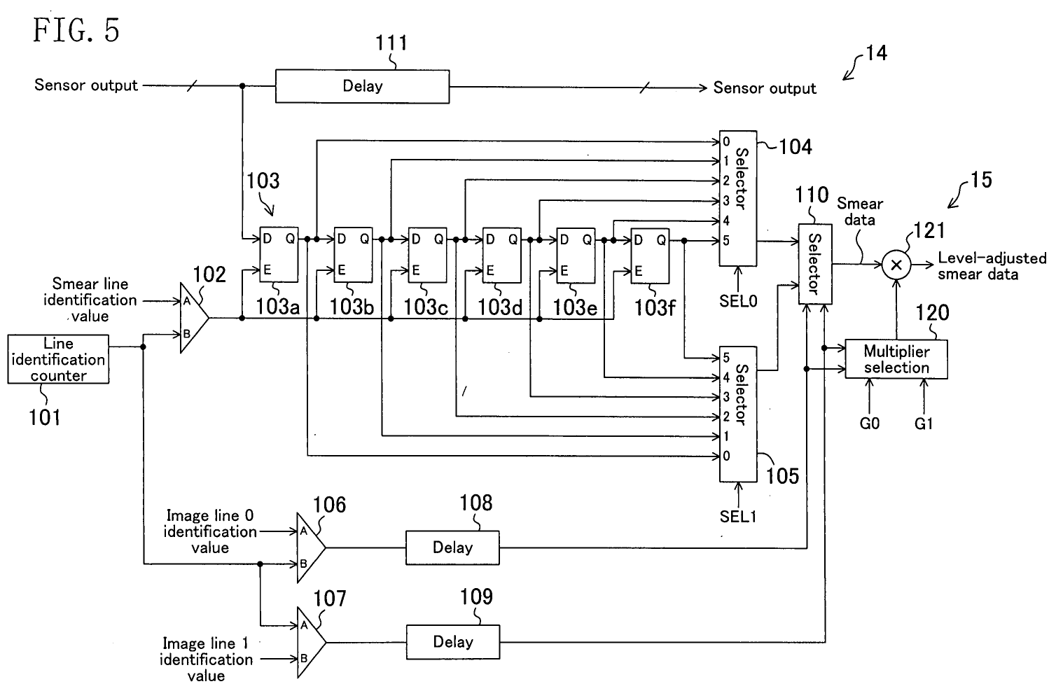

FIG. 5 shows a specific configuration of the smear sampling section 14 and the level adjustment section 15. Referring to FIG. 5, the smear sampling section 14 includes a line identification counter 101, identification gates 102, 106 and 107, a smear data storing section 103, selectors 104, 105 and 110, and delay sections 108, 109 and 111. The level adjustment section 15 includes a multiplier selection section 120 and a multiplication section 121.

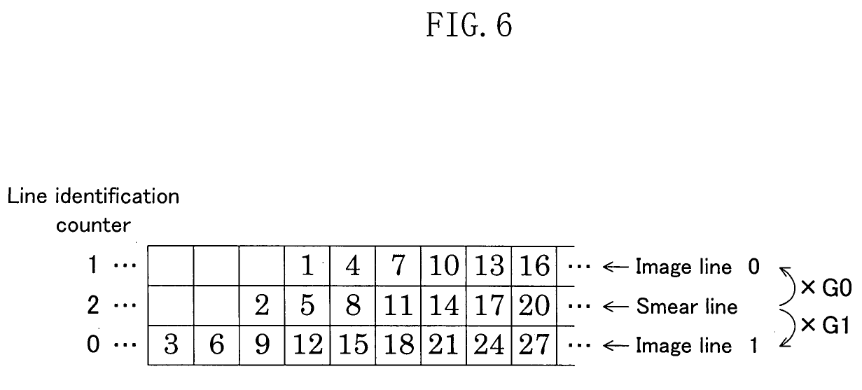

The line identification counter 101 is a ternary counter in synchronism with the sensor output data, and repeatedly outputs values “0”, “1” and “2”. By using the output of the line identification counter 101, it is possible to extract only the smear data from the sensor output data. Assume that the output of the line identification counter 101 of “1” corresponds to the image line 0, “2” to the smear line, and “0” to the image line 1, as shown in FIG. 6.

The identification gate 102 asserts the output when the output of the line identification counter 101 matches the smear line identification value, i.e., “2”. The smear data storing section 103 includes a predetermined number (6 in FIG. 5) of memory elements 103a to 103f connected together in series, and takes in the sensor output data when the output of the identification gate 102 is asserted. At the same time, the already stored data is shifted. Through this operation, the smear data storing section 103 always retains the 6 latest pieces of smear data.

The selectors 104 and 105 each selectively output one of the smear data stored in the memory elements 103a to 103f according to the selection signals SEL0 and SEL1, respectively. The output of the selector 104 is smear data corresponding to the data of the image line 0, and the output of the selector 105 is smear data corresponding to the data of the image line 1. The selection signals SEL0 and SELL are set according to the amount of shift in the order of output between the image data and the smear data in the same column.

The identification gate 106 asserts the output when the output of the line identification counter 101 matches the image line 0 identification value, i.e., “1”. The identification gate 107 asserts the output when the output of the line identification counter 101 matches the image line 1 identification value, i.e., “0”. The outputs of the identification gates 106 and 107 are delayed through the delay sections 108 and 109, respectively, so as to be timed with the outputs from the selectors 104 and 105, and then are given to the selector 110 as selection signals.

The selector 110 outputs the output of one of the selectors 104 and 105 as smear data according to the selection signal. Specifically, the output of the selector 104 is selectively output when the output of the identification gate 106 is being asserted, and the output of the selector 105 is selectively output when the output of the identification gate 107 is being asserted. If the outputs of the identification gates 106 and 107 are neither asserted, the output of the selector 110 is unknown.

The sensor output data is delayed through the delay section 111 so as to be timed with the smear data output from the selector 110. Through such an operation, smear data and sensor output data are output from the smear sampling section 14. The line identification counter 101, the identification gate 102 and the smear data storing section 103 together form first means for extracting smear data from the sensor output data and storing a predetermined number of pieces of smear data. The delay section 111 forms second means for delaying the sensor output data. The selectors 104, 105 and 110, the line identification counter 101, the identification gates 106 and 107 and the delay sections 108 and 109 together form third means for selectively outputting smear data from the first means so as to correspond to each image data in the sensor output data after being delayed by the second means.

Assume that the multiplier G0 is used for adjusting the smear level for a smear correction of the image line 0, and the multiplier G1 is used for adjusting the smear level for a smear correction of the image line 1, as shown in FIG. 6. The multiplier selection section 120 receives the outputs of the identification gates 106 and 107 as selection signals, and selects a multiplier by which the smear data is multiplied. The multiplier G0 for the image line 0 is selected when the output of the identification gate 106 is being asserted, and the multiplier G1 for the image line 1 is selected when the output of the identification gate 107 is being asserted. The multiplication section 121 multiplies the smear data output from the selector 110 by the multiplier selectively output from the multiplier selection section 120. Through such an operation, the level of the smear data is adjusted by the level adjustment section 15.

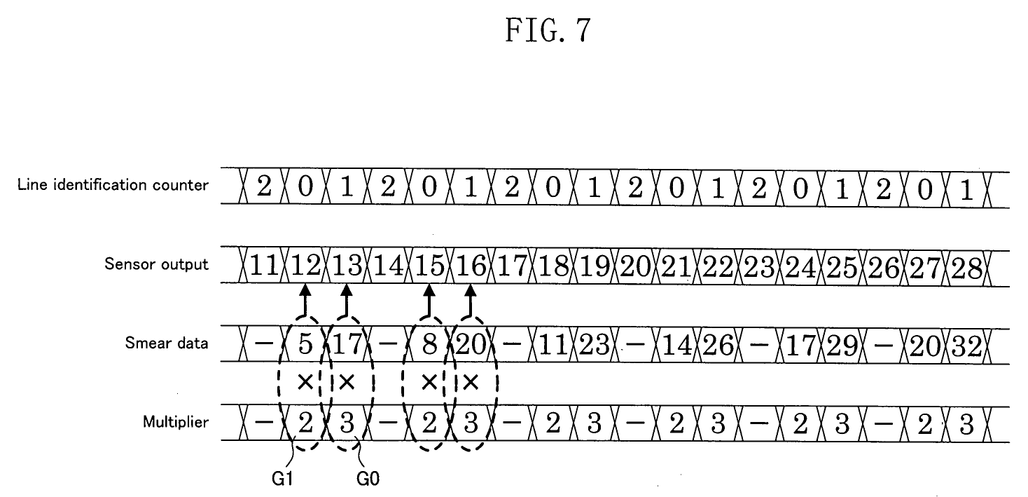

FIG. 7 shows an example of a temporal transition of each data, corresponding to FIG. 6, in the configuration of FIG. 5. As shown in FIG. 7, the sensor output data (“11”, “14”, “17”, . . . ) when the output of the line identification counter 101 is “2” are successively stored in the smear data storing section 103, and the selector 110 outputs smear data corresponding to each data of the image line 0 or 1 from among the stored data. For example, smear data “8” is output for data “15” of the image line 1, and smear data “20” is output for data “16” of the image line 0. The multiplier is selected according to whether the smear data is for the image line 0 or for the image line 1. In the example of FIG. 7, the multiplier G0 for the image line 0 is 3, and the multiplier G1 for the image line 1 is 2.

Through such an operation, it is possible to separate smear data from the output signal from the solid-state image sensor having specifications as described above, adjust the level of the separated smear data, and output the adjusted smear data, timed with the image data.

With the configuration of FIG. 5, the smear line may be any of the three lines to be output, and such a variation can be accommodated by appropriately setting the smear line identification value. Moreover, a variation in the amount of shift in the order of output between the image data and the smear data can also be accommodated by appropriately setting the selection signals SEL1 and SEL2 of the selectors 104 and 105. In a case where the amount of shift in the order of output may possibly be greater than ±8, the number of memory elements of the smear data storing section 103 can be increased so as to increase the number of smear data from which the selection is made.

The number of image lines being greater than two can be accommodated by increasing the counter upper limit value of the line identification counter 101 and increasing the number of the selectors 104 and 105 for selecting smear data and the number of the identification gates 106 and 107 for image lines.

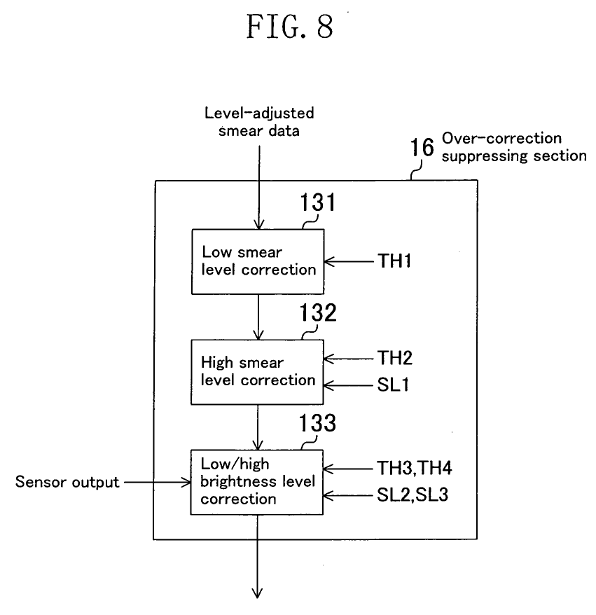

FIG. 8 is a block diagram showing a configuration of the over-correction suppressing section 16. The over-correction suppressing section 16 of FIG. 8 includes a low smear level correction section 131 for correcting the smear data when the level thereof is too low, a high smear level correction section 132 for correcting the smear data when the level thereof is too high, and a low/high brightness level correction section 133 for correcting the smear data when the level thereof is too low or too high.

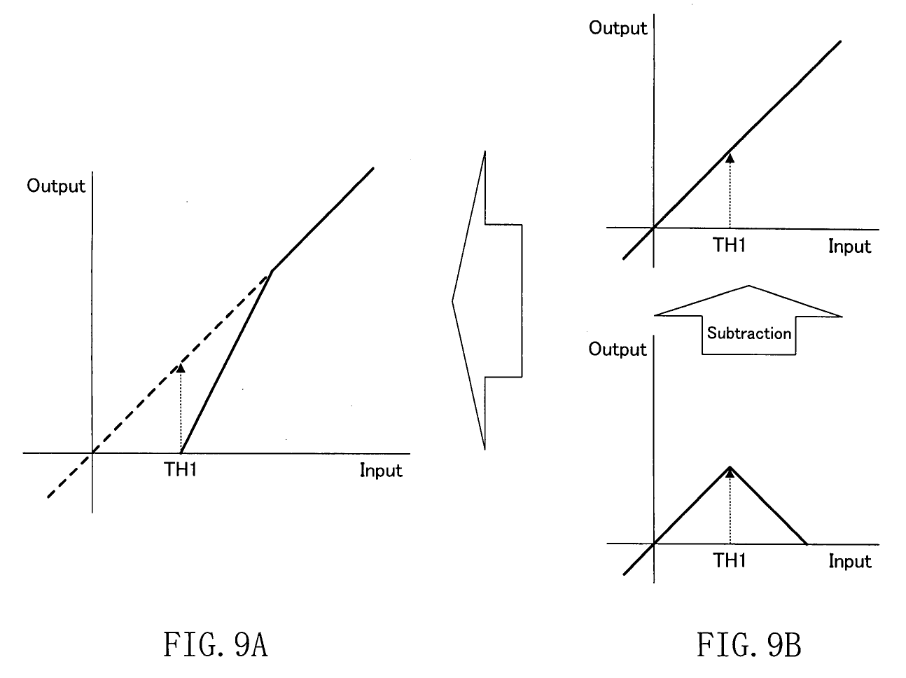

When the level of the smear data is too low, the low smear level correction section 131 corrects the smear data in order to avoid a deterioration of S/N through subtraction of the smear data. Specifically, a correction operation as shown in FIG. 9A is performed, for example. That is, when the input smear data is below a predetermined threshold value TH1, the smear data is set to zero. A correction operation as shown in FIG. 9A is realized by, for example, providing a calculation section having an input/output relationship as shown in the lower half of FIG. 9B and subtracting the output of this calculation section from the input smear data. Where the smear data level is below the threshold value TH1, it is not always necessary to set the smear data level to zero, but some effect of avoiding an S/N deterioration can be obtained by decreasing the smear data level.

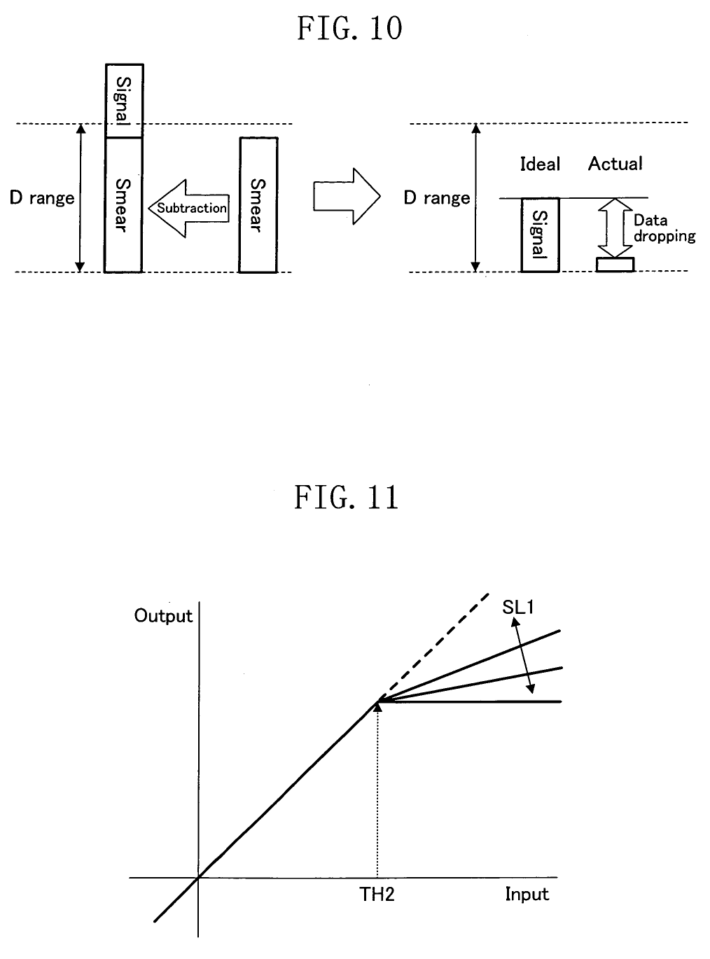

The high smear level correction section 132 corrects the smear data in order to avoid data dropping through excessive subtraction of smear data when the smear data level is too high. As shown in FIG. 10, where the smear component is too large and the sum of the smear component and the signal component substantially exceeds the image sensor dynamic range, if such large smear data is subtracted from the image data, there may occur data dropping. In view of this, where the smear data level is too high, the smear data is corrected by the high smear level correction section 132. Specifically, a correction operation as shown in FIG. 11 is performed, for example. That is, when the input smear data is over a predetermined threshold value TH2, a correction value SL1 smaller than 1 is applied to the smear data to decrease the level of the smear data. Such a correction operation can easily be implemented by digital circuit techniques.

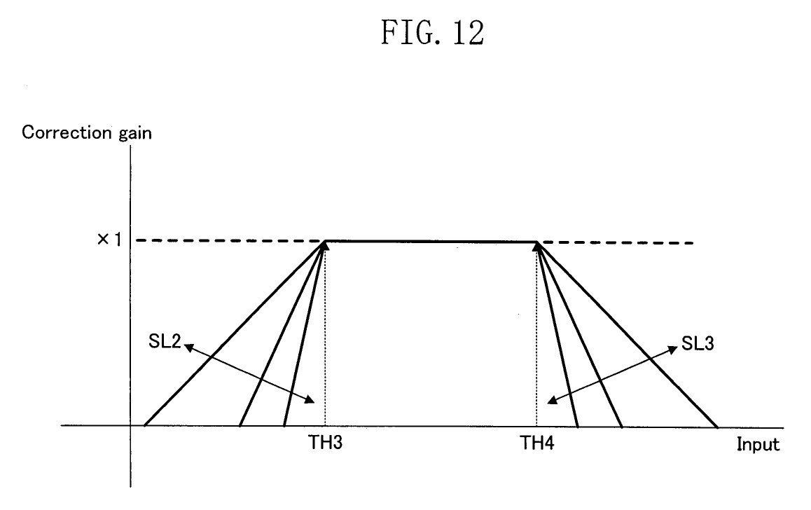

When the level of image data is too low or too high, the low/high brightness level correction section 133 corrects smear data corresponding to the image data. The purpose of correcting smear data when the level of image data is too low is to avoid an S/N deterioration through subtraction of smear data. The purpose of correcting smear data when the level of image data is too high is to avoid data dropping through excessive subtraction of smear data. Specifically, a correction operation as shown in FIG. 12 is performed, for example. That is, when the input image data is below a predetermined first threshold value TH3, the correction gain of the smear data is set to a value smaller than 1 to thereby decrease the level of the smear data. The gradient SL2 used when lowering the correction gain is also adjustable. Also when the input image data is above a predetermined second threshold value TH4, the correction gain of the smear data is set to a value smaller than 1 to thereby decrease the level of the smear data. The gradient SL3 used when lowering the correction gain is also adjustable.

The operation performed by the over-correction suppressing section 16 is not limited to that described above. For example, the correction using smear data in the low smear level correction section 131 and the high smear level correction section 132 is not limited to the method shown in FIGS. 9A, 9B and 11, but may alternatively be a method as shown in FIG. 12, for example. Moreover, one or two of the low smear level correction section 131, the high smear level correction section 132 and the low/high brightness level correction section 133 may be omitted. Depending on the specifications, the over-correction suppressing section 16 may be omitted.

The subtraction circuit 17 subtracts the corrective smear data output from the over-correction suppressing section 16 from the image data received from the smear sampling section 14. Thus, a smear correction is implemented.

The OB level correction section 13 may perform an OB level correction separately for each line. Thus, even if the OB level varies between lines, such variations can be corrected. Specifically, an OB level correction value may be set for each of the image lines 0 and 1 and the smear line shown in FIG. 2, and the corresponding OB level correction value may be subtracted from each line by using the output of the line identification counter 101 described above.

As described above, the present embodiment is directed to a CCD solid-state image sensor, which alternately outputs, pixel by pixel, N lines of image signal and a line of smear signal for correcting the N lines of image signal by switching an output line from one to another, wherein a CCD signal processing device separates corrective smear data corresponding to each of the N lines of image data and subtracts the corresponding corrective smear data from each image data, thereby performing a smear correction. Therefore, it is possible to appropriately perform a smear correction even if a high-brightness object moves.

### Second Embodiment

A second embodiment of the present invention aims at avoiding an S/N deterioration, which occurs when subtracting smear data from image data due to the influence of random noise, etc., existing in the smear data.

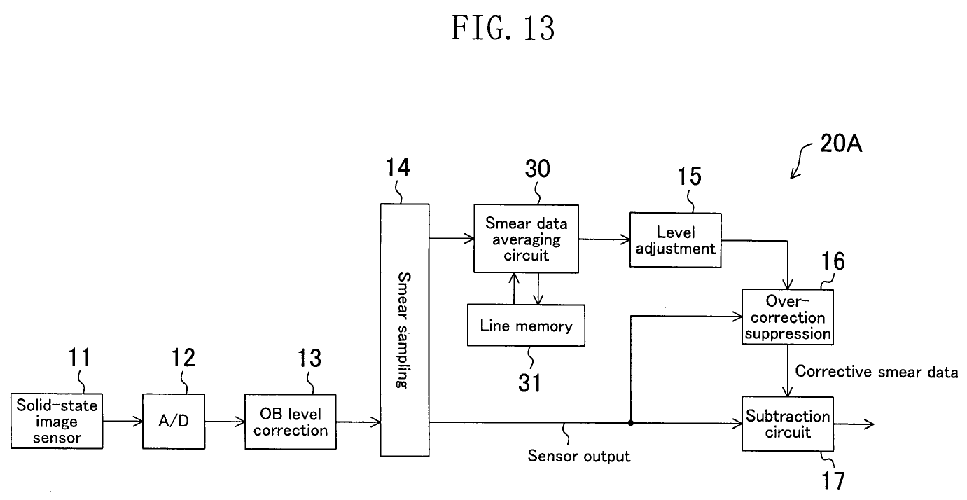

FIG. 13 is a block diagram showing an image sensing device including a CCD signal processing device according to the present embodiment. In FIG. 13, like elements to those shown in FIG. 1 are denoted by like reference numerals and will not be further described below.

Referring to FIG. 13, a smear data separation section 20A includes a smear data averaging circuit 30 and a line memory 31 for storing a line of smear data, in addition to the smear sampling section 14, the level adjustment section 15 and the over-correction suppressing section 16. The smear data averaging circuit 30 performs an averaging operation on the smear data extracted by the smear sampling section 14 by using a piece of smear data stored in the line memory 31 that is in the same column. The averaged smear data is stored again in the line memory 31 and is output to the level adjustment section 15.

The averaging operation performed by the smear data averaging circuit 30 may be a filtering operation such as an FIR (Finite Impulse Response) operation or an IIR (Infinite Impulse Response) operation, for example. Alternatively, the extracted smear data and the smear data stored in the line memory 31 may be compared with each other so that either the larger one or the smaller one is used.

By performing the averaging operation, the output timing of the corrective smear data is delayed from that in the first embodiment, it can be timed with the sensor output data by, for example, adjusting the delay time at a delay section 11 shown in FIG. 5.

Thus, the corrective smear data that is subtracted from the sensor output in the subtraction circuit 17 is the smear data after being averaged. Therefore, it is possible to avoid a deterioration in the S/N of the image data due to an influence of random noise existing in the smear data.

### Third Embodiment

A third embodiment of the present invention aims at avoiding problems such as smear on an obtained image being colored due to the influence of the pixel arrangement in the solid-state image sensor 11 and the driving method thereof, or image data dropping due to over-correction of smear data, in a case where a high-brightness object, being the cause of smear, is a point light source.

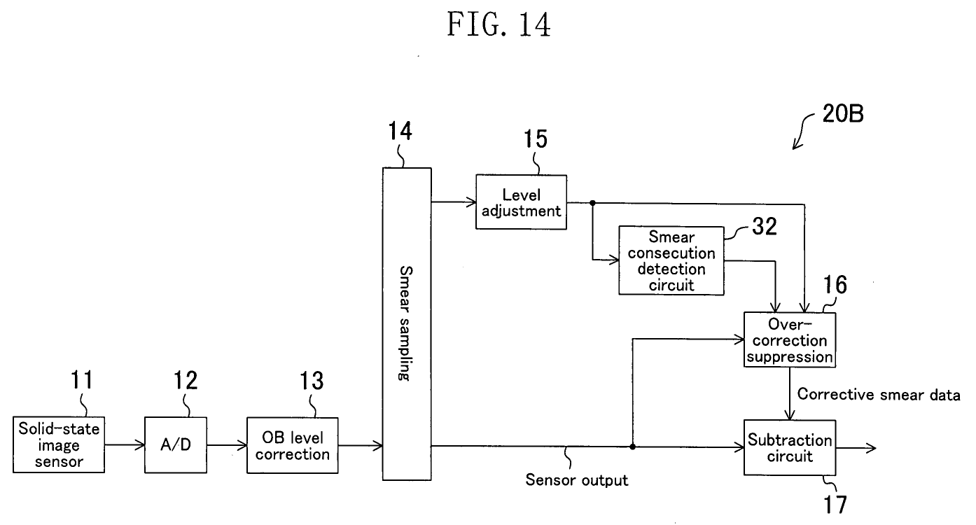

FIG. 14 is a block diagram showing an image sensing device including a CCD signal processing device according to the present embodiment. In FIG. 14, like elements to those shown in FIG. 1 are denoted by like reference numerals and will not be further described below.

Referring to FIG. 14, a smear data separation section 20B includes a smear consecution detection circuit 32, in addition to the smear sampling section 14, the level adjustment section 15 and the over-correction suppressing section 16. The smear consecution detection circuit 32 determines whether the level of the smear data output from the level adjustment section 15 exceeds a predetermined smear level threshold value consecutively for a number of pixels exceeding a predetermined threshold number of consecutive pixels. If it is determined by the smear consecution detection circuit 32 that there is no such consecution, the over-correction suppressing section 16 performs a correction by lowering the level of the smear data output from the level adjustment section 15.

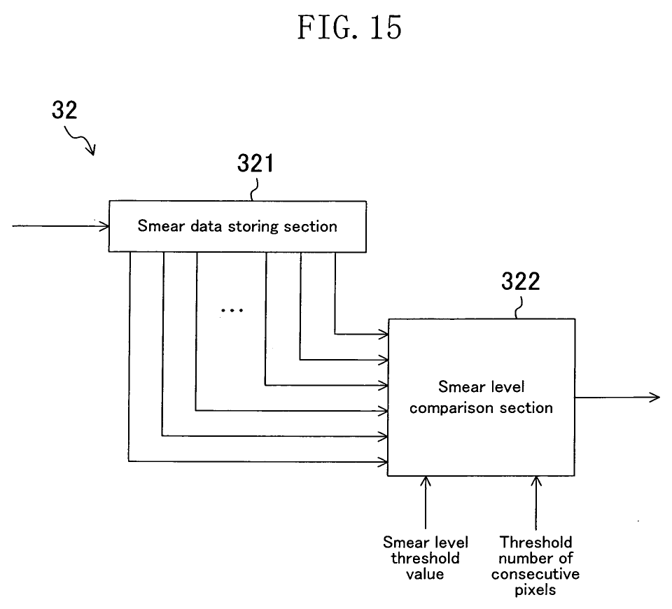

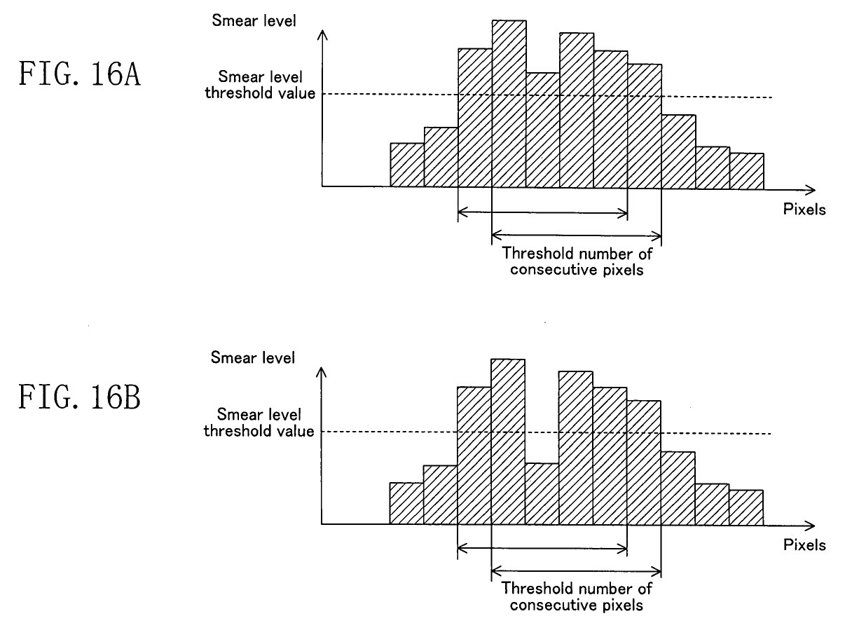

FIG. 15 shows a specific configuration of the smear consecution detection circuit 32. FIGS. 16A and 16B illustrate a determination operation by the smear consecution detection circuit 32. Referring to FIG. 15, the smear consecution detection circuit 32 includes a smear data storing section 321 for successively storing a predetermined number of pixels of smear data, and a smear level comparison section 322 for performing a comparison determination operation with the input being a predetermined number of pixels of smear data stored in the smear data storing section 321. The smear level comparison section 322 is given a smear level threshold value as the first threshold value, and a threshold number of consecutive pixels as the second threshold value. Then, as shown in FIGS. 16A and 16B, it is determined whether the level of the input smear data exceeds the smear level threshold value consecutively for a number of pixels exceeding the threshold number of consecutive pixels. FIG. 16A shows a case where the level exceeds the smear level threshold value consecutively for a number of pixels exceeding the threshold number of consecutive pixels, and FIG. 16B shows a case where there is no such consecution.

The smear consecution detection circuit 32 outputs the determination result to the over-correction suppressing section 16. Where the determination result is “no consecution”, the number of pixels for which the smear level threshold value is exceeded (the number of consecutive smeared pixels) is preferably output together with the result.

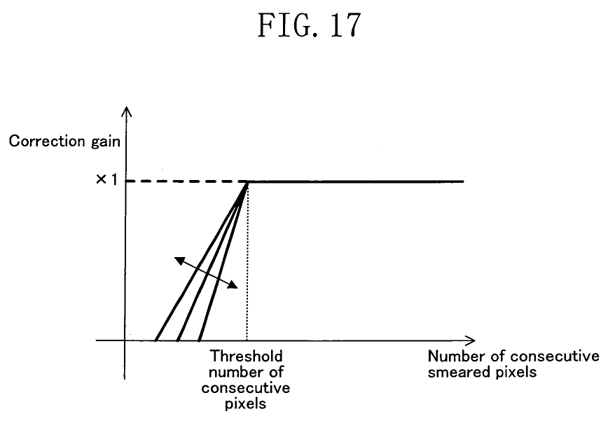

FIG. 17 shows an example of a correction operation performed by the over-correction suppressing section 16 according to the present embodiment. As shown in FIG. 17, the over-correction suppressing section 16 maintains the correction gain at “1” if the determination result of the smear consecution detection circuit 32 is “consecution” (i.e., if the number of consecutive smeared pixels exceeds the threshold number of consecutive pixels). If the determination result of the smear consecution detection circuit 32 is “no consecution”, the correction gain is set to be smaller than “1”. The correction gain may be set smaller as the number of consecutive smeared pixels output from the smear consecution detection circuit 32 is smaller. The gradient used when lowering the correction gain is also adjustable.

Thus, the corrective smear data that is subtracted from the sensor output in the subtraction circuit 17 is suppressed to be small in a case where smear is not occurring consecutively. Therefore, it is possible to avoid problems such as smear on an image being colored or image data dropping in a case where the cause of the smear is a point light source.

### Fourth Embodiment

A fourth embodiment of the present invention aims at avoiding the lowering of the smear suppressing effect due to the lowering of the correlation between the smear component contained in the image data and the corrective smear data because of a movement of a high-brightness object.

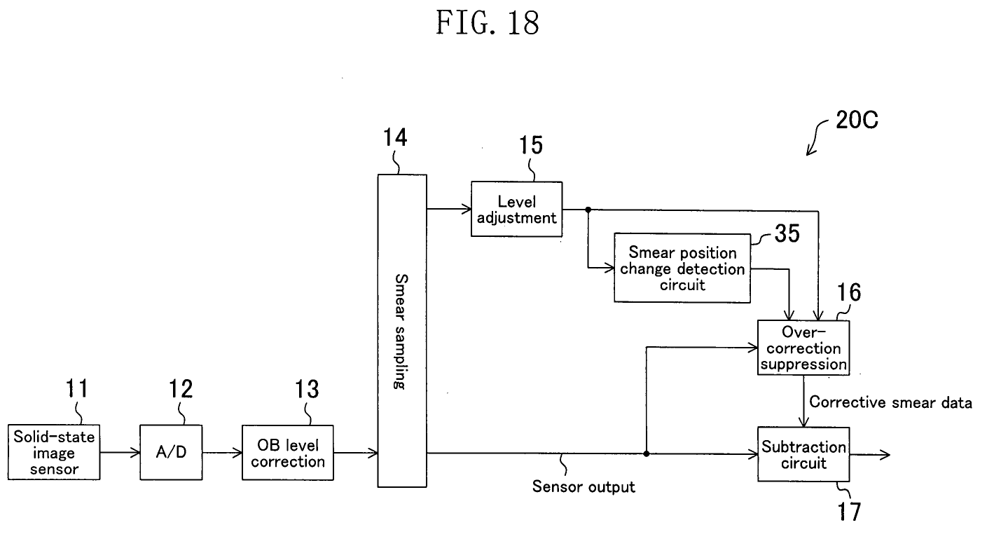

FIG. 18 is a block diagram showing an image sensing device including a CCD signal processing device according to the present embodiment. In FIG. 18, like elements to those shown in FIG. 1 are denoted by like reference numerals and will not be further described below.

Referring to FIG. 18, a smear data separation section 20C includes a smear position change detection circuit 35, in addition to the smear sampling section 14, the level adjustment section 15 and the over-correction suppressing section 16. The smear position change detection circuit 35 determines, for the smear data output from the level adjustment section 15, whether the position of the range of smear is changing over a plurality of lines. The over-correction suppressing section 16 corrects the smear data output from the level adjustment section 15 if it is determined by the smear position change detection circuit 35 that there is such a change.

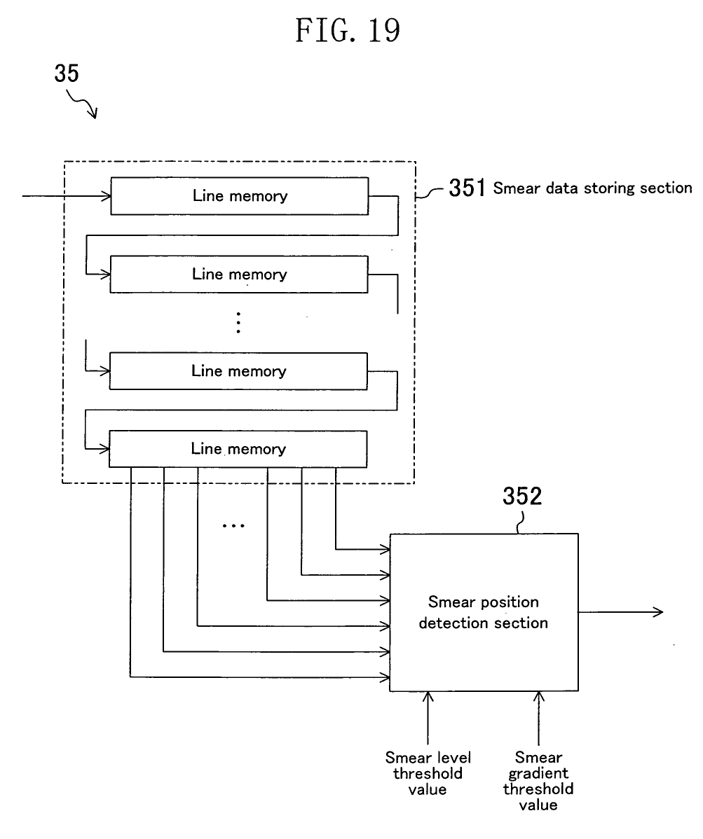

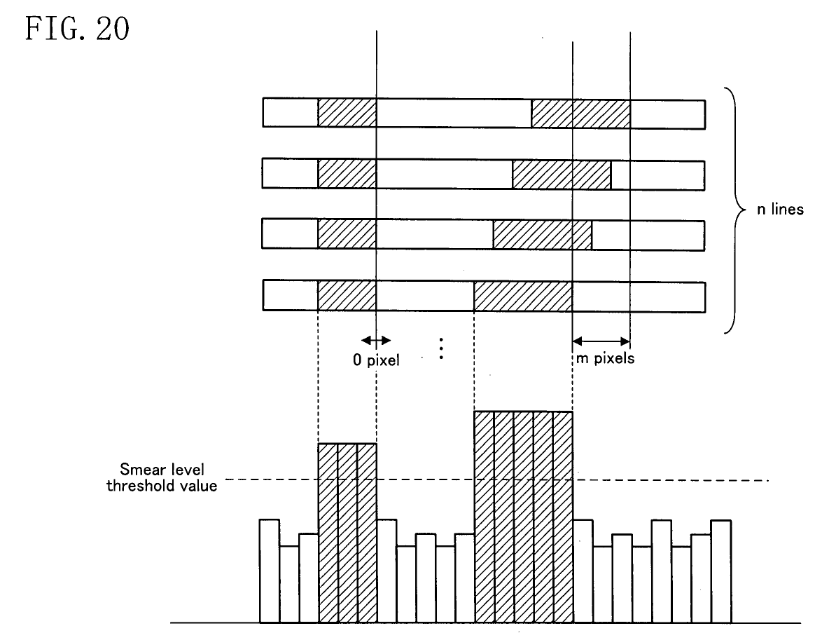

FIG. 19 shows a specific configuration of the smear position change detection circuit 35. FIG. 20 illustrates a determination operation of the smear position change detection circuit 35. Referring to FIG. 19, the smear position change detection circuit 35 includes a smear data storing section 351 for successively storing a predetermined number of lines of smear data, and a smear position detection section 352 for performing a smear position detection operation with the input being each line of smear data stored in the smear data storing section 351. The smear position detection section 352 is given a smear level threshold value as a predetermined threshold value, and a smear gradient threshold value. Then, referring to FIG. 20, it is determined whether the position of the range of the input smear data where the smear level threshold value is exceeded (i.e., hatched portions in the figure) is changing over a plurality of lines, exceeding a predetermined limit indicated by the smear gradient threshold value. Specifically, where the range where the smear level threshold value is exceeded for n lines moves by m pixels,

smear gradient=n/m

(where the gradient is at maximum when m=0) is calculated, and it is determined whether the value is below the smear gradient threshold value. If the value is below the smear gradient threshold value, it is determined that the change of the smear position exceeds a predetermined limit.

The smear position change detection circuit 35 outputs the determination result to the over-correction suppressing section 16. If the determination result is that “the change exceeds the predetermined limit”, the smear gradient is preferably output together with the result. The determination result represents whether a high-brightness object being the cause of smear has moved, and the speed of the movement.

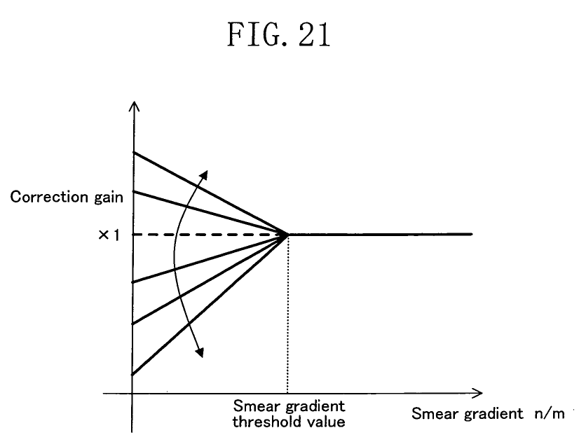

FIG. 21 shows an example of a correction operation performed by the over-correction suppressing section 16 according to the present embodiment. As shown in FIG. 21, if the determination result of the smear position change detection circuit 35 is that “the change does not exceed the predetermined limit” (i.e., if the smear gradient exceeds the smear gradient threshold value), the over-correction suppressing section 16 maintains the correction gain at “1”. If the determination result of the smear position change detection circuit 35 is that “the change exceeds the predetermined limit”, the correction gain is changed. The gradient used when changing the correction gain is also adjustable.

Thus, where the smear position is changing over a plurality of lines, the corrective smear data that is subtracted from the sensor output in the subtraction circuit 17 is corrected accordingly. Therefore, it is possible to avoid the lowering of the smear suppressing effect due to the movement of the high-brightness object.

The present invention, with which it is possible to appropriately perform a smear correction operation even if a high-brightness object moves, is effective for use in an image sensing device capable of outputting high-quality image data, for example.

What is claimed is:

1. A CCD signal processing device for processing a signal output from a CCD solid-state image sensor, wherein:
the CCD solid-state image sensor alternately outputs, pixel by pixel, N (where N is an integer of 2 or more) lines of image signal and a line of smear signal for correcting the N lines of image signal by switching an output line from one to another;
the CCD signal processing device includes:
an AD conversion section for performing an AD conversion on the output signal from the CCD solid-state image sensor to output the converted signal as sensor output data including image data and smear data;
a smear data separation section for separating smear data from the sensor output data output from the AD conversion section and converting the separated smear data to corrective smear data corresponding to each image data; and
a subtraction circuit for performing a smear correction by subtracting, from image data of the sensor output data outputted from the AD conversion section, the corrective smear data corresponding to the image data output from the smear data separation section.

2. The CCD signal processing device of claim 1, wherein the smear data separation section includes:
a smear sampling section for extracting smear data corresponding to each image data from the sensor output data; and
a level adjustment section for adjusting a level of each smear data extracted by the smear sampling section according to the corresponding image data.

3. The CCD signal processing device of claim 2, wherein the smear sampling section includes:
first means for extracting smear data from the sensor output data and storing a predetermined number of smear data;
second means for delaying the sensor output data; and
third means for selectively outputting smear data from the first means so as to correspond to each image data in the sensor output data after being delayed by the second means.

4. The CCD signal processing device of claim 2, wherein the smear data separation section includes:
a line memory for storing a line of smear data; and
a smear data averaging circuit for performing an averaging operation on smear data extracted by the smear sampling section by using a piece of smear data stored in the line memory that is in the same column,
wherein the averaged smear data is stored again in the line memory and is output to the level adjustment section.

5. The CCD signal processing device of claim 2, wherein the smear data separation section further includes an over-correction suppressing section for performing a correction operation on the smear data output from the level adjustment section so as to suppress excessive smear correction through subtraction.

6. The CCD signal processing device of claim 5, wherein the over-correction suppressing section includes a low smear level correction section for lowering a level of smear data when the level of the smear data is below a predetermined threshold value.

7. The CCD signal processing device of claim 5, wherein the over-correction suppressing section includes a high smear level correction section for lowering a level of smear data when the level of the smear data exceeds a predetermined threshold value.

8. The CCD signal processing device of claim 5, wherein the over-correction suppressing section includes a low/high brightness level correction section for lowering a level of smear data when a level of image data corresponding to the smear data is below a predetermined first threshold value or above a predetermined second threshold value.

9. The CCD signal processing device of claim 5, wherein:
the smear data separation section includes a smear consecution detection circuit for determining whether a level of smear data output from the level adjustment section exceeds a predetermined first threshold value consecutively for a number of pixels exceeding a predetermined second threshold value; and
the over-correction suppressing section performs a correction by lowering the level of the smear data when it is determined by the smear consecution detection circuit that there is no such consecution.

10. The CCD signal processing device of claim 5, wherein:
the smear data separation section includes a smear position change detection circuit for determining whether a range of smear data output from the level adjustment section where a level of the smear data exceeds a predetermined threshold value is changing over a plurality of lines by a degree exceeding a predetermined limit; and
the over-correction suppressing section corrects the level of the smear data if it is determined by the smear position change detection circuit that the range is changing by a degree exceeding the predetermined limit.

11. The CCD signal processing device of claim 1, further comprising an OB level correction section for correcting an OB level of the sensor output data output from the A/D conversion section by using an independent correction value for each line.

12. An image sensing device, comprising:
a CCD solid-state image sensor for alternately outputting, pixel by pixel, N (where N is an integer of 2 or more) lines of image signal and a line of smear signal for correcting the N lines of image signal by switching an output line from one to another; and
the CCD signal processing device of claim 1 for processing the signal output from the CCD solid-state image sensor.
